(19) United States
(12) Patent Application Publication
(10) Pub. No.: US 2007/0200947 A1
(43) Pub. Date: Aug. 30, 2007

(54) Focus adjustment method and focus adjustment apparatus

(76) Inventors: Atsushi Kobaru, Hitachinaka (JP); Hiroki Kawada, Tsuchiura (JP)

Correspondence Address: MCDERMOTT WILL & EMERY LLP, 600 13TH STREET, N.W., WASHINGTON, DC, 20005-3096, US

(21) Appl. No.: 11/699,064

(22) Filed: Jan. 29, 2007

(30) Foreign Application Priority Data
Feb. 24, 2006 (JP) 2006-047907

(51) Int. Cl. G03B 13/00

(52) U.S. Cl. 348/345

(57) ABSTRACT

A focus adjustment method and a focus adjustment apparatus suited to realize both higher precision and faster speed of focus adjustment are provided. More specifically, the focus adjustment method and apparatus of this invention determine a focus adjustment quantity based on a relation between a change in a focus position value and a change in a focus evaluation value or a relation between the focus position value and the focus evaluation value, namely, a gradient of the focus evaluation value in a focus position direction. As one example, an excitation current to be supplied to an objective lens (or a voltage to be applied to a specimen) is calculated based on the relation between a change in the excitation current (or voltage applied to the specimen) and a change in the focus evaluation value.

### BACKGROUND OF THE INVENTION

The present invention relates to a focus adjustment in a charged particle beam device and more particularly to a method and an apparatus for performing the focus adjustment based on a signal obtained by the charged particle beam device, e.g., a focus evaluation value calculated from an image signal.

Conventionally, scanning electron microscopes (SEMs), one of the charged particle beam devices, make the focus adjustment by calculating the focus evaluation value based on an image obtained from secondary electrons released from a specimen and adjusting an objective lens in a way that increases the focus evaluation value. JP-A-5-266851 and JP-A-10-31969 describe that the adjustment of an objective lens is performed by obtaining a plurality of images by continuously changing an excitation current of the objective lens, extracting an image with a high focus evaluation value and using the excitation current corresponding to the extracted image in adjusting the objective lens. In JP-A-2005-175465 (corresponding to US 2005/0127293), it is described that the focus adjustment is repeated until a difference between a measured focus evaluation value and a predetermined value falls within a specified range.

The method that measures the evaluation value for each focus by changing the focus stepwise, as explained in JP-A-5-266851 and JP-A-10-31969, requires changing the excitation current over a wide range including a peak of the focus evaluation value, in order to detect the excitation current that produces the highest focus evaluation value. Further, to enhance the precision of the focus adjustment it is necessary to detect a true peak accurately, which in turn requires reducing the step in which the excitation current is changed. This makes it necessary to obtain a large number of images from which to measure the focus evaluation values, with the result that a significant amount of time elapses before the focusing operation is completed.

Also in the method that acquires an ideal focus evaluation value beforehand and repetitively performs the focus adjustment to bring the measured focus evaluation value closer to the ideal value, as in the case with JP-A-2005-175465, if the focus adjustment is executed with high precision, the focus adjustment step must be set small, making it difficult to meet both demands for higher precision and faster execution of the focus adjustment.

### SUMMARY OF THE INVENTION

It is an object of the present invention to provide a focus adjustment method and a focus adjustment apparatus, both suited to realize enhanced precision and faster execution of focus adjustment.

To achieve the above objective, this invention proposes a method and an apparatus to determine a focus adjustment quantity based on a value representing a relation between a change in a focus position value and a change in a focus evaluation value, or a value representing a relation between the focus position value and the focus evaluation value, namely a gradient of the focus evaluation value, a continuous quantity, in a direction of focus position (an inclination at a particular position of a graph obtained by plotting the focus evaluation values at different focus positions). As one example, a method is proposed which calculates a current value to be supplied to the objective (or a voltage value to be applied to a specimen) based on a value representing a relation between a change in the excitation current (or the voltage applied to the specimen) and a change in the focus evaluation value.

Adjusting the current to be applied to the objective according to this gradient allows the focus adjustment to be made according to a difference between the pre-adjustment focus position and a final focused position. This in turn makes it possible to appropriately determine a focus moving step used in acquiring a focus evaluation image repetitively.

That is, when the gradient is large, this means that the focus position before adjustment is greatly deviated from the focused point. So, moving the focus position in large steps can increase the focusing speed. When the gradient is small, this means that the pre-adjustment focus position is close to the focused point. In that case, moving the focus position in small steps can enhance the precision.

The above construction can provide a focus adjustment method and device that can realize both an increased speed and an enhanced precision in the focus adjustment.

Other objects, features and advantages of this invention will become apparent from the following descriptions of embodiments of this invention with reference to the accompanying drawings.

### BRIEF DESCRIPTION OF THE DRAWINGS

FIG. 1 illustrates a configuration of an embodiment of this invention.

FIG. 2 illustrates a control system to calculate an excitation current based on a differentiated focus evaluation value.

FIG. 3 is a flow chart for the embodiment of this invention.

FIGS. 4A and 4B are diagrams of a PID control.

FIG. 5 illustrates a magnetic hysteresis of an objective lens.

FIG. 6 is a graph showing a relation between the excitation current of the objective lens and the focus evaluation value.

### DESCRIPTION OF THE EMBODIMENTS

One preferred embodiment of this invention will be explained by referring to the accompanying drawings.

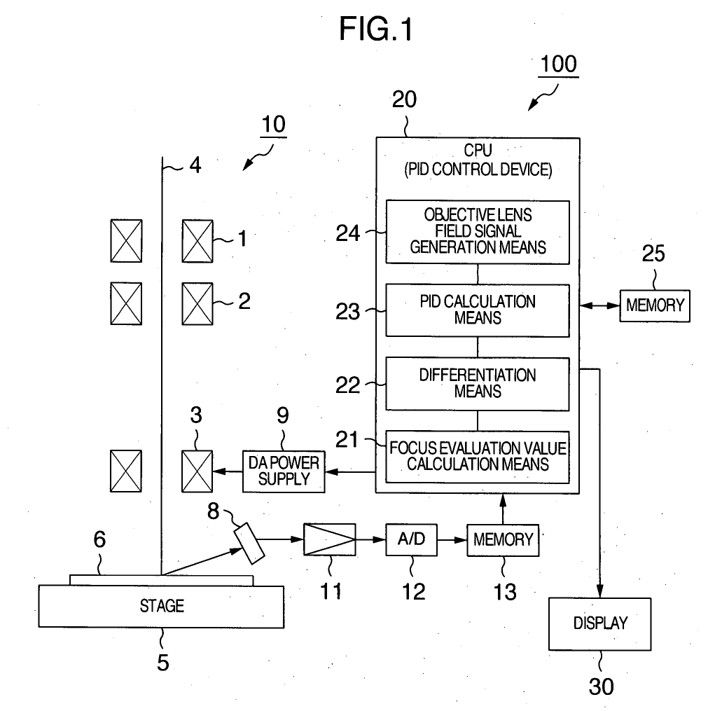

FIG. 1 is a schematic diagram of a scanning electron microscope, one of charged particle beam devices. Although the following description takes up the scanning electron microscope as an example, this invention is also applicable to other charged particle beam devices, such as scanning ion microscopes and scanning transmission electron microscopes, and to optical devices that form an image based on signals produced by shining light, such as optical microscope. In other words, the invention is generally applicable to devices that perform the focus adjustment according to an acquired image.

In the scanning electron microscope shown in FIG. 1, an electron beam 4 emitted from an electron source not shown is scanned one- or two-dimensionally over a specimen 6 by deflectors 1, 2. The electron beam 4 is focused on the specimen 6 by an objective lens 3. Secondary electrons and/or backscattered electrons from the specimen are directly or indirectly detected by a detector 8 and amplified by an amplifier 11. A signal amplified by the amplifier 11 is then analog/digital-converted by an A/D converter 12 and stored in a frame memory 13. Since the detected signal is stored in the frame memory 13 in synchronism with a scan signal supplied to the deflectors 1, 2, the information stored in the frame memory 13 represents a magnified imaged of surface undulations of the specimen 6 in the scan area of the electron beam 4.

A central processing unit (CPU) 100 is configured or programmed to make a focus adjustment according to predetermined steps. More specifically, the CPU 100 measures a focus evaluation value of an image stored in the frame memory 13 and, based on the focus evaluation value, calculates an excitation current to be supplied to the objective lens 3 or a control signal to a power supply 9 that supplies the excitation current to the objective lens 3.

A memory 25 stores device parameters and programs required to control the scanning electron microscope 10 and sends information to the CPU 100 as required. The CPU 100 is connected to an input device not shown for information necessary to control the scanning electron microscope.

The CPU 100 incorporates a focus evaluation value calculation means 21 to calculate the focus evaluation value from the image stored in the frame memory 13. A differential means 22 calculates information on a gradient that represents a relation between a change in the excitation current or signal supplied to the power supply 9 and a change in the focus evaluation value. In this example, the differential means 22 determines a gradient of the focus evaluation value in the focus position direction by calculating (dFu/di) (n) based on an excitation current change dn and a focus evaluation value change dFu. If there is no gradient, i.e., (dFu/di) (n)=0, the microscope is in a focused state. If an absolute value of (dFu/di) (n) is large or dFu/dn is outside a predetermined range including 0, the focus position is deviated from the focused point. In this example, a PID calculation means 23 is used to calculate the excitation current to be supplied to the objective lens 3 according to the gradient information. The excitation current in this example is calculated by substituting the gradient information as a deviation for the PID control. Based on a calculated result from the PID calculation means 23, an objective lens magnetic field signal generation means 24 sends to the power supply 9 a signal that causes the power supply to supply a desired amount of excitation current to the objective lens 3. Variables necessary for the PID control, such as a proportional gain Kp, are registered with the memory 25 in advance.

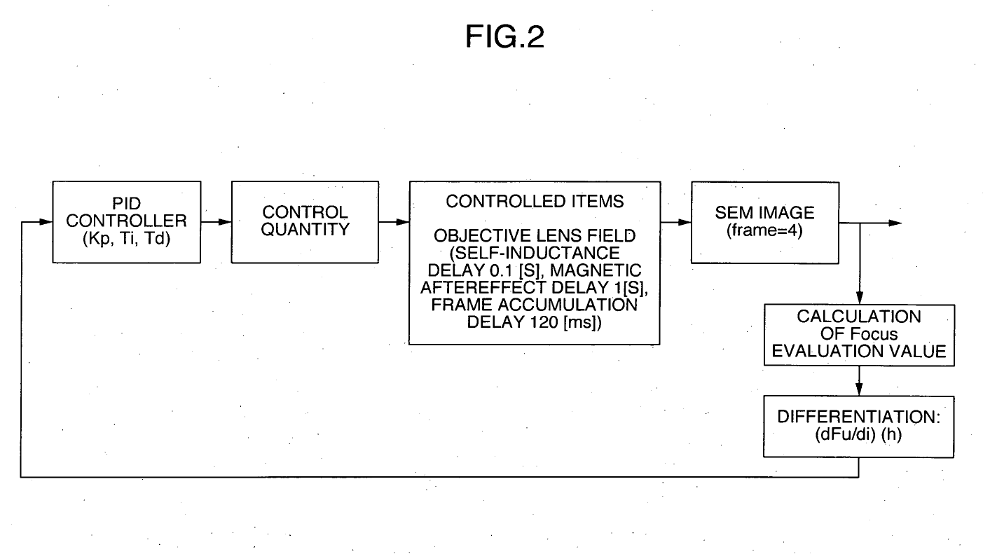

FIG. 2 shows an example of a control system to calculate an excitation current of the objective lens based on a differentiated focus evaluation value. This example explains how the focus evaluation value is obtained from accumulated four SEM images stored in the frame memory 13. The obtained focus evaluation value is differentiated to determine (dFu/di) (n). In this example, a PID control is used to adjust the excitation current of the objective lens based on this differentiated value or a value representing a gradient of the focus evaluation value waveform. More specifically, a signal to be supplied to the power supply 9 is calculated according to equation (1).

$$MV = Kp ( e + \frac{1}{Ti} \int e ⅆ t + Td \frac{ⅆ e}{ⅆ t} ) + {MV}_{0} \qquad ( 1 )$$

where VM is an operation quantity, e is a deviation, Kp is a proportional gain, Ti is an integration time, Td is a differentiation time and MVc is an initial value of the operation quantity.

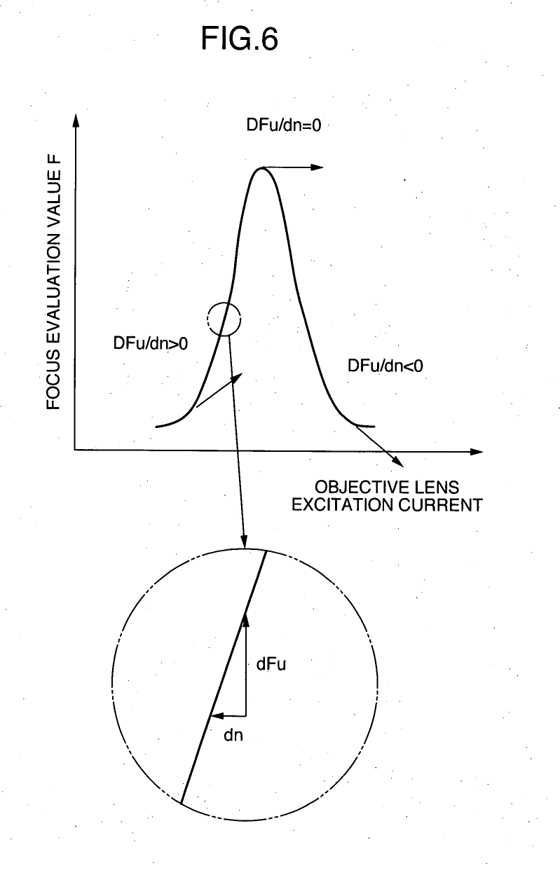

In this equation, (dFu/di) (n) or a value representing a gradient is substituted as the deviation e. Calculating in this way can control the magnitude of the signal supplied to the power supply 9 or the excitation current. If, as a result of the calculation, the absolute value of the gradient is large or the gradient is largely deviated from zero and is outside the predetermined range, requiring a significant amount of adjustment to get to the just focus state, a large lens control quantity is set. If, on the other hand, the gradient is small or within the predetermined range close to zero, requiring only a small adjustment to reach the just focus state, a small lens control quantity is set. This makes it possible to control the excitation current, which in turn allows a high-speed, high-precision focus adjustment. FIG. 6 is a graph showing a relation between the excitation current of the objective lens and the focus evaluation value. A point where the focus evaluation value is maximum is a just focus point, and the object of this example is to make an adjustment quickly and precisely to produce the excitation current for the maximum focus evaluation value. In this example, a relation (dFu/di) (n) between a change dn in a value representing the focus position (in this example, excitation current) and a change dFu in the focus evaluation value is calculated and, based on this relation, the excitation current is determined.

Although this example uses (dFu/di) (n) as the deviation e in the PID control equation, other value according to the magnitude of (dFu/di) (n) may be used. For example, when threshold 1≦(dFu/di) (n)<threshold 2, deviation e=predetermined value a may be used; when threshold 2≦(dFu/di) (n)<threshold 3, deviation 3=predetermined value b may be used; and so on.

Further, as shown in FIG. 6, increasing the excitation current of the objective lens makes the differential value positive on the left side of the peak and minus on the right side. It is therefore possible to determine whether to reduce or increase the excitation current according to whether the differential value is positive or negative. When it is deviated from the peak greatly, the differential value is close to zero, making it difficult to distinguish from the peak portion. In that case, if, when the excitation current is changed largely, the focus evaluation value decreases significantly or changes in steps more than the predetermined value, the focus position may be decided to be near the peak portion. If the focus evaluation value does not change much or does not change in steps more than the predetermined value, the focus position may be decided to be greatly deviated from the peak. This explanation is only one example and a variety of adaptations may be made depending on circumstances.

The PID operation quantity MV is output from the PID calculation means 23 to the objective lens magnetic field signal generation means 24. This output value is converted by the power supply 9 into the excitation current that controls the objective lens.

The excitation current I_{M} supplied from the power supply 9 to the objective lens 3 is calculated by a magnetic field response equation (2).

$${I}_{M} ( t ) = \frac{E}{R} ( 1 - {ⅇ}^{\frac{t}{{τ}_{1}}} ) ( 1 - k {ⅇ}^{- \frac{t}{{τ}_{2}}} ) \qquad ( 2 )$$

τ₁ and τ₂ are constants characteristic of the objective lens, a self-inductance delay and a delay based on a magnetic aftereffect. E represents a voltage applied to a coil of the objective lens. R represents a resistance of the coil.

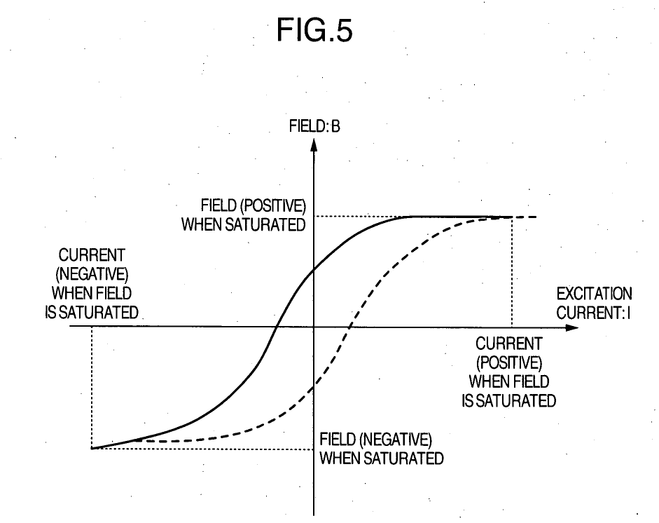

In the case of the magnetic field type objective lens, the magnetic hysteresis of FIG. 5 may prevent the excitation current and the focus evaluation value from being kept in a predetermined relation. When the focus is changed stepwise by changing the excitation current in a predetermined step, there is a problem that the focus is not easily fixed because of the instability of the relation between the excitation current and the focus evaluation value. In this example, however, since the operation quantity is changed according to the gradient of the focus evaluation value in the focus position direction, a stable focus adjustment can be made, free from the magnetic hysteresis.

Although this example calculates the operation quantity based on the so-called PID control, other controls, such as a P control (proportional action) or a PI control (proportional and integral actions), may be used. Further, while this example takes up a case where an adjustment is made of the excitation current of the magnetic field type objective lens, other focus adjustment methods may be employed, including a so-called retarding focus method that performs a focus adjustment by adjusting a negative voltage applied to the specimen 6 through the specimen stage 5.

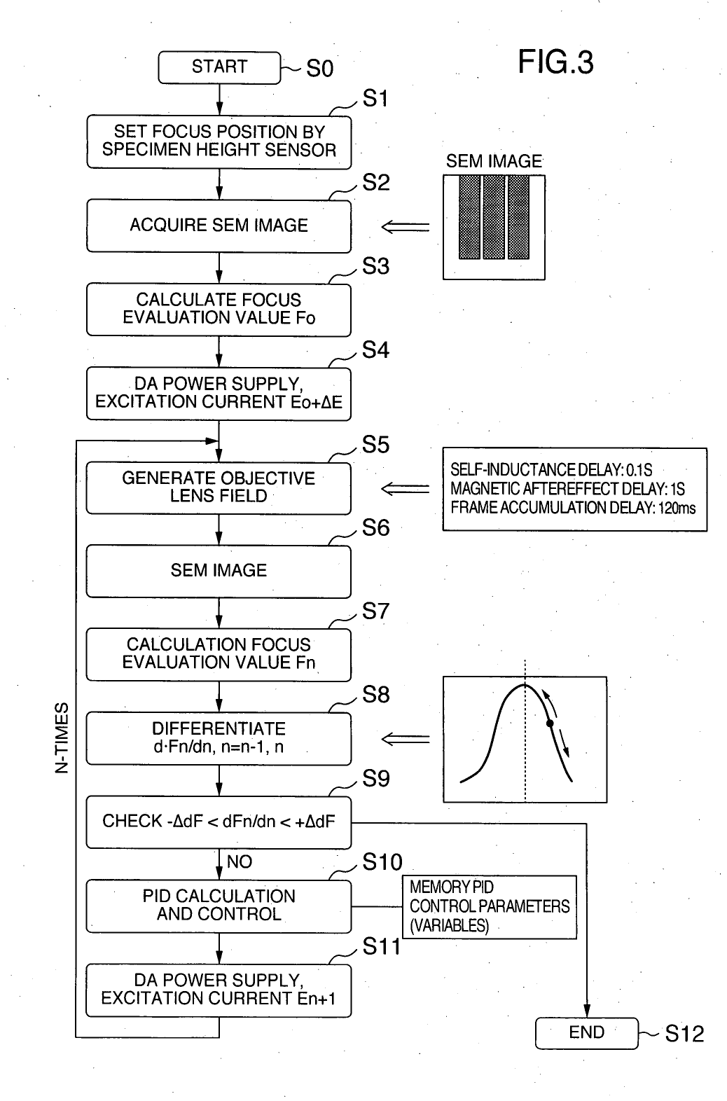

FIG. 3 shows a flow of processing to implement this embodiment. First, the height of the specimen is measured by a specimen height sensor not shown and, based on the measurement, an excitation current of the objective lens is set to Eo to make a rough setting of the focus position (S0, S1). In this state, an electron beam is scanned to acquire a SEM image (S2).

Next, based on the acquired SEM image, a focus evaluation value Fo is calculated (S3). The focus evaluation value of the SEM image may use a variance of differential values of pixel signal strengths of the image in an area of interest. Such a calculation may be executed by the CPU 100.

Next, the excitation current supplied from the power supply 9 is set to Eo+ΔE to produce an objective lens field (S5).

Next, with the excitation current of the objective lens set at Eo+Δ, an electron beam is scanned over the specimen to form a SEM image based on electrons scattered from the scan area on the specimen (S6). Based on the acquired SEM image, a focus evaluation value Fn is calculated (S7).

Next, the calculated focus evaluation value Fn is differentiated by the above differentiation means to determine (dFu/di) (n) (S8). If (dFu/di) (n) is positive, the excitation current is short of what is needed to obtain the just focus state. If (dFu/di) (n) is negative, the excitation current is excessive. According to the calculated value of (dFu/di) (n), the direction (plus or minus) in which the excitation current should be changed to adjust the focus can be detected. Further, a check is made as to whether −ΔdF<(dFu/di) (n) (ΔdF is a predetermined threshold) is met (S9). If (dFu/di) (n) falls in this range, it is decided that an appropriate objective lens excitation current is set, ending the control sequence (S12). If not, a feedback is executed with (dFu/di) (n) as an observation quantity.

Although the objective lens has a magnetic hysteresis as shown in FIG. 5, the above feedback control can quickly determine the focus conditions.

Variables for use in the PID control are characteristic of the objective lens and their preadjusted values are stored in memory.

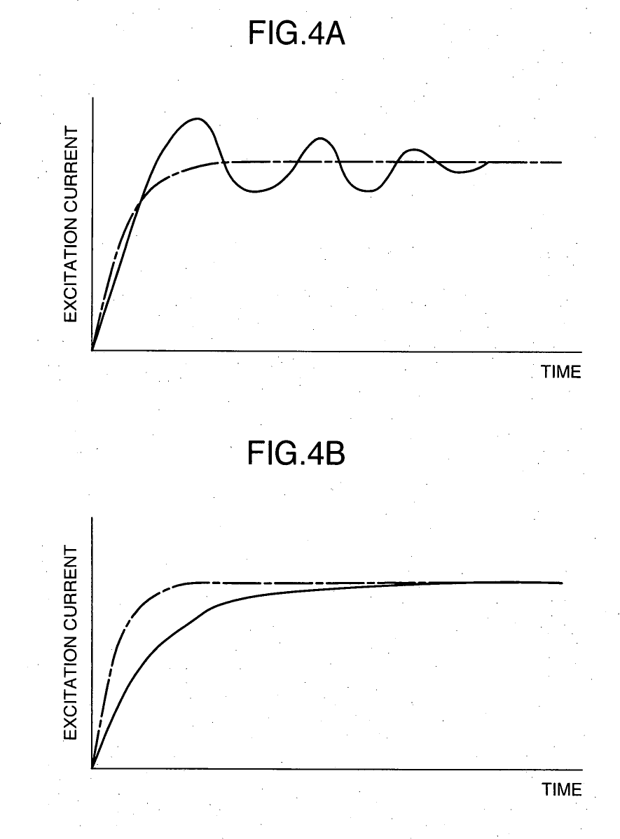

Parameters for the PID control are determined by tuning in advance and are stored in memory. If two or more values are registered for one parameter, an operator may choose an appropriate parameter on a display. Well-known general tuning methods include a step response method and a limitation sensitivity method. One selection of the tuning method may involve matching the excitation current value to a curve when an appropriate parameter is set, as shown in FIG. 4A or FIG. 4B. FIG. 4B represents a case where the excitation current is moderated at its initial leading edge and converged to a final target value. FIG. 4A represents a case where the excitation current is raised quickly at the initial leading edge to shorten the time required to converge to the final target value. With this method, a stable feedback control can be implemented which can reduce the focusing time and prevent an overshoot.

The excitation current En+1 to be supplied from the power supply 9 to the objective lens is calculated from the above equation (S11). This excitation current is applied to the objective lens to generate a flux field of the objective lens S6). In the following steps, the above processing is repeated until (dFu/di) (n) falls in the predetermined range.

With this example, a focus adjustment can be made of the objective lens by an appropriate control quantity.

Although the above description has been made for one embodiment, it is obvious to a person skilled in the art that this invention is not limited to this embodiment and that various changes and modifications may be made within the spirit of this invention and the scope of the appended claims.

1. A focus adjustment method for adjusting a focus of a charged particle beam based on a focus evaluation value, the focus evaluation value being calculated from an image acquired by scanning the charged particle beam, the focus adjustment method comprising the steps of:
calculating a relation between a change in a focus position value and a change in the focus evaluation value when a lens condition for adjusting the focus of the charged particle beam is changed;
calculating a control quantity of the lens based on the relation; and
controlling the lens based on the control quantity.

2. A focus adjustment method according to claim 1, wherein the relation is one between the focus position value and the focus evaluation value, i.e., a value related to a gradient of the focus evaluation value, which is a continuous quantity, in a focus position direction.

3. A focus adjustment method according to claim 1, wherein the relation is a value related to a differentiated value of the focus evaluation value.

4. A focus adjustment method according to claim 3, wherein the calculation of the relation, the calculation of the lens control quantity and the control of the lens are repeated until an absolute value of the differentiated value is less than a predetermined value or falls in a predetermined range including zero.

5. A focus adjustment method according to claim 1, wherein the focus position value is a value related to an excitation current supplied to the lens.

6. A focus adjustment method according to claim 1, wherein the focus position value is a value related to a negative voltage applied to a specimen.

7. A focus adjustment apparatus to calculate a control signal for a lens in a charged particle beam device based on a focus evaluation value of an image acquired by the charged particle beam device, the focus adjustment apparatus being adapted to calculate a relation between a change in a focus position value and a change in the focus evaluation value when a lens condition for adjusting a focus of a charged particle beam is changed, and to calculate a control quantity of the lens based on the relation.

8. A focus adjustment apparatus according to claim 7, wherein the relation is one between the focus position value and the focus evaluation value, i.e., a gradient of the focus evaluation value, which is a continuous quantity, in a focus position direction.

9. A focus adjustment apparatus according to claim 7, wherein the relation is a differentiated value of the focus evaluation value.

10. A focus adjustment apparatus according to claim 9, wherein the calculation of the relation and the calculation of the lens control quantity are repeated until an absolute value of the differentiated value is less than a predetermined value or falls in a predetermined range including zero.

11. A focus adjustment apparatus according to claim 7, wherein the focus position value is a value related to an excitation current supplied to the lens.

12. A focus adjustment apparatus according to claim 1, wherein the focus position value is a value related to a negative voltage applied to a specimen.
